(19) United States
(12) Patent Application Publication
(10) Pub. No.: US 2006/0112998 A1
(43) Pub. Date: Jun. 1, 2006

(54) Multi-layered hose

(75) Inventor: Frank M. Smith, Chino Hills, CA (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Tekni-Plex, Inc., Somerville, NJ (US)

(21) Appl. No.: 11/268,441

(22) Filed: Nov. 7, 2005

Related U.S. Application Data
(60) Provisional application No. 60/632,242, filed on Dec. 1, 2004.

(51) Int. Cl. F16L 11/00

(52) U.S. Cl. 138/137

(57) ABSTRACT

A multi-layered hose comprising, in cross section, a) a plurality of layers defining b) a channel, said hose having a density less than that of water at the same temperature. The hose is particularly suitable for use in connection with substantially nonvolatile fluid transfer, for example pool cleaning and the like since it is capable of floating on a water surface.

### CROSS-REFERENCE TO RELATED APPLICATIONS

This application claims the benefit of the filing date of U.S. Provisional Patent Application No. 60/632,242 filed Dec. 1, 2004, the disclosure of which is hereby incorporated herein by reference.

### BACKGROUND OF THE INVENTION

Floating multi-layered hoses have been employed previously in the transportation of fuel. See. e.g. U.S. Pat. Nos. 5,640,771 and 6,634,389. These hoses are expensive to produce and are directed at containing highly volatile liquids and gasses and would be ill-suited for transporting more mundane fluids. Hoses have been used in pool cleaning for many years. See e.g. U.S. Pat. Nos. 5,348,051 and 4,753,256. However, none have employed a multi-layered design to facilitate floatation of the hose. One of the common problems with these hoses is that they are susceptible to sinking, especially when filled with water. Then, upon operation of the pool cleaning device, the hose can become tangled inhibiting the flow of the water through the hose and limiting the range of motion of the pool cleaning device. Previous methods of solving this problem included affixing flotation devices to the hose but these solutions presented additional problems such as the floatation devices falling off the hose and the added expense of such floatation devices. See. e.g. U.S. Pat. Nos. 5,195,563 and 4,503,874. The present invention solves these and other problems by providing a multi-layered hose that floats without the need for additional flotation devices.

### SUMMARY OF THE INVENTION

A multi-layered hose comprising in cross section, a plurality of layers defining a channel, said multi-layered hose having a density less than that of water at the same temperature. The hose is particularly suitable for use in connection with substantially nonvolatile fluid transfer, for example pool cleaning and the like where it is capable of floating on a water surface.

### BRIEF DESCRIPTION OF THE DRAWINGS

FIG. 1 shows a cross section of a hose.

FIG. 2 shows a cross section of the plurality of layers making up the hose.

### DETAILED DESCRIPTION OF THE INVENTION

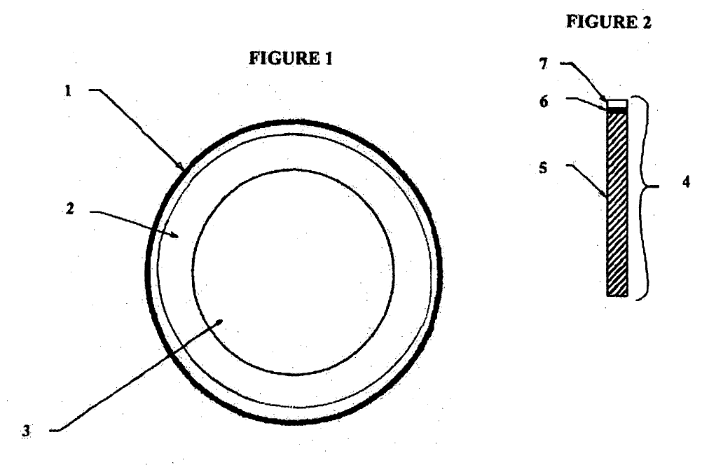

Referring to FIG. 1, one aspect of the present invention is a multi-layered hose (1) comprising a plurality of layers (2) that define a channel (3). FIG. 2 illustrates a preferred embodiment of the invention wherein the plurality of layers (4) comprise an innermost layer (5), at least one intermediate layer. (6), and an outermost layer (7).

A preferred embodiment of the present invention is a multi-layered hose comprising in cross-section, (a) a plurality of layers and (b) a hollow channel defined by said plurality of layers, wherein said multi-layered hose has a density less than that of water at the same temperature.

The hose of the present invention comprises lightweight durable materials suitable for an indoor or outdoor environment, allowing the hose to be exposed to the elements as well as various shocks, vibrations, temperature changes, and exposure to chlorinated water, body oils, and potentially other chemicals without suffering significant degradation of the materials. It is anticipated that the hose of the present invention would be operational and well-tolerant of temperatures ranging from about 40° F to about 120° F. It is contemplated that the hose of the present invention would not suffer significant detrimental effects at moderately higher or lower temperatures.

When referred to herein, “polymer” includes homopolymers, copolymers, and terpolymers.

Preferably, the plurality of layers comprises an innermost layer, at least one intermediate layer, and an outermost layer. It is contemplated that additional layers could be added or that only two layers could be used, although a two layer construction may prove less functional or desirable. The plurality of layers of the present invention is preferably selected from the group consisting of thermoplastic polyolefin elastomers, ethylene vinyl acetate copolymers (hereinafter “EVA”), and polyvinyl chloride compositions (hereinafter “PVC”) . It is contemplated that other suitable polymeric materials can be used including, copolyester ethers available from Eastman Chemical Company under the trade name Ecdel, e.g. grade 9966; thermoplastic vulcanizates in all grades under the trade name Santoprene available from Advanced Elastomer Systems; saturated styrene block copolymer rubbers and thermoplastic olefin resins in all grades available from Teknor Apex under the trade name Monoprene; ethylene methyl acrylate copolymers in all grades available from Eastman Chemical Company under the trade name EMAC; polyolefin elastomer blends in all grades available from DSM under the trade name Sarlink; styrenic block copolymers based on styrene, butadiene and isoprene monomers in all grades available from Kraton Polymers under the tradename Kraton or from GLS under the trade name Dynaflex; alternatively, thermoplastic polyurethanes, and thermoplastic rubbers could be used in this invention. It is additionally contemplated that other polymers not listed could be used provided that a stable construction is produced, i.e., the layers do not delaminate under reasonable conditions of use and the resulting hose is capable of floating. It is further contemplated that additional materials such as fillers or reinforcing elements could be added to any of the aforementioned materials used to make up the plurality of layers, provided that this addition does not increase the density of the hose such that it is no longer less dense than water at the same temperature or that it does not float. The reinforcing elements could comprise threads, fibers, or woven or nonwoven substrates comprising such threads or fibers and mixtures thereof. These reinforcing elements can be natural or synthetic.

The innermost layer may comprise thermoplastic polyolefin elastomers. A preferred type of thermoplastic polyolefin elastomer is an ethylene octene copolymer of any grade or a mixture of such polymers (preferably from DuPont/Dow under the trade name Engage®). More preferably the ethylene octene copolymer is Engage 8665. Alternatively, or in a mixture, the thermoplastic polyolefin elastomer can be ethylene butene copolymer (available from DuPont/Dow under the trade name Engage®) . It is also contemplated that suitable polymers for the innermost layer can be selected from the group consisting of copolyester ethers such as the 9966 grade (available from Eastman Chemical Company under the trade name Ecdel), thermoplastic vulcanizates in all grades (available from Advanced Elastomer Systems under the trade name Santoprene), saturated styrene block copolymer rubbers and thermoplastic olefin resins in all grades (available from Teknor Apex under the trade name Monoprene), ethylene methyl acrylate in all grades (available from Eastman Chemical Company under the trade name EMAC), polyolefin elastomer blends in all grades (available from DSM under the trade name Sarlink), and styrenic block copolymers based on styrene, butadiene and isoprene monomers in all grades (available from Kraton Polymers under the trade name Kraton or from GLS under the trade name Dynaflex). Alternatively, one skilled in the art can select other materials for the innermost layer based on characteristics including thermoplasticity, low density, and the ability to adhere to the outermost layer by use of an intermediate polymeric adhesion layer.

The at least one intermediate layer preferably comprises ethylene vinyl acetate (EVA). The EVA can have any suitable vinyl acetate content such that the copolymer can be extruded and serve to adhere the innermost and outermost layers. Typically the EVA can have a vinyl acetate content of about 10% to about 28% by weight; preferably about 18% to about 28% by weight; more preferably about 24% to about 28% by weight. The vinyl acetate content is most preferably about 28% by weight. A suitable polymer is available from DuPont under the trade name Elvax® 265. It is also contemplated that the at least one intermediate layer may also include, e.g., other grades of EVA, either alone or in a mixture. Alternate polymers such as all Dupont EVAs, all Equistar EVAs including Equistar UE624-000, Equistar UE634-04 and Equistar UE630-000 can be used either alone, in separate layers, or in a mixture in a single intermediate layer. Alternatively, one skilled in the art may select other materials for the at least one intermediate layer based on the teachings herein. [0013] The outermost layer preferably comprises polyvinyl chloride compositions, such compositions referred to herein as PVC. As will be clear from the following disclosure, reference herein to “PVC” means a polyvinyl chloride composition comprising polyvinyl chloride resin, not the resin itself. These polyvinyl chloride compositions comprise polyvinyl chloride resin, plasticizer, and other common additives including antioxidants, stabilizers, ultraviolet resistance improving additives, toners, and other additives known to those of skill in the art. The plasticizer of the polyvinyl chloride is preferably present in the range of about 20% to about 65% of the composition by weight and is selected from the group consisting of DEHP, TOTM, DOA, DOP, and citrates. Preferably the polyvinyl chloride composition, or PVC, comprises polyvinyl chloride homopolymer resin in about 54% to about 61% by weight of the composition, di-2-ethylhexyl phthalate in about 32% to about 36% by weight of the composition, epoxidized soybean oil in about 2% to about 7% by weight of the composition, organo zinc soap blend in about <0.01% by weight of the composition, calcium stearate in about <0.001% by weight of the composition, and pigment in about <0.001% by weight of the composition. Most preferably the PVC is PTN-775-02 available from Natvar, a Tekni-Plex company. Preferably the PVC has a durometer of about 60 to about 95 Shore A. Other grades of PVC are suitable for use herein, such grades varying in chlorine content, molecular weight, and/or viscosity of the polyvinyl chloride homopolymers as well as the content of plasticizers and/or oils. Useful PVCs include any commercially available PVC compositions using available polyvinyl chloride homopolymers and other typical components, including those recited above, that satisfy the performance criteria expressed herein, including durometer hardness, e.g., Shore A, and burst strength of the resulting hose structure, discussed hereinafter. Suppliers of PVCs include Colorite Polymers, Teknor Apex, Alpha Gary, and Hoffman. It is also contemplated that the outermost layer may also be selected from PVC, thermoplastic elastomers, thermoplastic polyurethanes, thermoplastic rubbers, EVA and mixtures thereof. Alternatively, one skilled in the art may select other materials for the outermost layer based on the teachings herein.

It is preferred that the innermost layer comprises at least one thermoplastic polyolefin elastomer, the outermost layer comprises at least one PVC and the at least one intermediate layer comprises at least one EVA copolymer. This configuration is preferred because the EVA functions to adhere the innermost and outermost layers together under conditions of manufacture and use.

The innermost layer may be any suitable thickness. It may typically have a thickness of about 0.005 inches to about 1.0 inches; preferably about 0.05 inches to about 0.25 inches; more preferably about 0.1 inches to about 0.15 inches; more preferably about 0.103 inches to about 0.118 inches. Most preferably, the innermost layer has a thickness of about 0.109 inches.

The at least one intermediate layer may be of any suitable thickness. It may have a thickness of about 0.001 inches to about 1.0 inches; preferably about 0.001 inches to about 0.1 inches; more preferably about 0.001 inches to about 0.01 inches; most preferably about 0.003 inches to about 0.005 inches.

The outermost layer may be any suitable thickness. It may have a thickness of about 0.001 inches to about 1.0 inches; preferably about 0.001 inches to about 0.1 inches; more preferably about 0.001 inches to about 0.05 inches most preferably about 0.005 inches to about 0.01 inches.

The thickness of the innermost and at least one intermediate layers may constitute any suitable percentage of the total thickness of the walls of the hose provided that the hose remains less dense than water as declared herein. The innermost and at least one intermediate layers may constitute about 50% to about 99% of the total thickness of the walls of the hose; preferably about 75% to about 95% of the total thickness of the walls of the hose; more preferably about 90% to about 95% of the total thickness of the walls of the hose. Most preferably, the innermost and at least one intermediate layer make up about 93% of the total thickness of the wall of the hose.

The hose of the present invention comprising a hollow chamber formed by the multiple layers described above may have any suitable diameter, if circular, or suitable cross-sectional dimension if of another shape, for example, oval, ellipsoidal, etc. A circular cross-section may have a diameter of about 0.002 inches to about 5.0 inches; preferably about 0.1 inches to about 1.0 inches; more preferably about 0.25 inches to about 0.75 inches; most preferably about 0.45 inches to about 0.55 inches.

The hose may have any suitable outer dimension, e.g., outside diameter. It may have an outside diameter of about 0.01 inches to about 10.0 inches; preferably about 0.25 inches to about 2.0 inches; more preferably about 0.5 inches to about 1.0 inches; most preferably about 0.7 inches to about 0.8 inches.

Overall, the dimensions of the hollow chamber and overall dimension are selected based on the volume of water, or other fluid, that must be transported through the hose, the properties of any device to which the hose is attached, and the requirement that the hose be capable of floating on the fluid it transports without the substantial assistance of separate flotation elements or devices. The thicknesses of the walls and the individual layers therein are also selected to provide a burst strength of between about 90 pounds per square inch (psi) to about 180 psi at 100° F and preferably about 100 psi to about 160 psi at 100° F while maintaining the buoyancy of the hose.

This invention is preferably manufactured using a tri-layer crosshead with three extruders, each one providing one material for the individual layers of the hose. The crosshead is preferably a high volume construction to achieve large outer diameters for hoses of various dimensions and large diameters for the hollow channels inside the hoses, while maintaining equivalent line speeds for PVC hose produced using in-line tooling. For example, the largest of the three extruders could be about 2.5 inches to about 4.0 inches. This largest extruder could supply the thickest layer of the product. This largest extruder could be used to supply the innermost layer, the thermoplastic polyolefin elastomer layer. The other two extruders could be about 1.25 inches to about 2.0 inches. These extruders can be used to supply the at least one intermediate layer and the outermost layer, for example, an EVA and PVC layer respectively. Non-contact vacuum sizing could be used to produce large-sized hoses. For smaller-sized hoses, free extrusion could be used. It is contemplated that printing of logos, sizes, descriptions, etc. can be performed using a print wheel or an inkjet printer to print directly onto the outer surface of the hose or alternatively that labels can be printed and affixed to the hose. It is also contemplated that color may be added to the outermost layer, for example the PVC polymer, prior to or during extrusion. It is preferred that the color be a concentrate with a let down ratio of about 1% to about 5% by weight. After extrusion the hose can be coiled or cut to length. The hose may also be extruded to a designated length. It is contemplated that one skilled in the polymer product manufacturing art could employ variations of these methods or different methods to produce the claimed invention. Furthermore, the cross-section of the hollow channel, as well as the intermediate and outermost layers, is not limited to a specific shape. For example the cross-section can be selected from such shapes as circular, elliptical, oval, irregular, corrugated etc. and combinations thereof. Furthermore, the outermost surface of the hose can be corrugated while the innermost surface can be regular.

In a particularly preferred embodiment, the invention is a floating pool hose used in connection with equipment and devices for cleaning pools. This embodiment comprises three layers of material that define a hollow channel. The floating pool hose comprises an innermost layer, an intermediate layer and an outermost layer. The innermost layer comprises at least one thermoplastic polyolefin elastomer. The intermediate layer comprises at least one EVA copolymer. The outermost layer comprises at least one PVC. In this particularly preferred embodiment, the innermost layer has a thickness of about 0.109 inches, the intermediate layer has a thickness of about 0.003 inches, and the outermost layer has a thickness of about 0.01 inches. Furthermore, the hose has an outer diameter of about 0.76 inches and the hollow channel at the approximate center of the hose has a diameter of about 0.516 inches.

The materials and dimensions of the preferred embodiment are selected to provide a hose that is less dense than water, or whatever fluid it is used with, thereby allowing it to float, while maintaining its durability and function. The selection of thermoplastic polyolefin elastomers for the innermost layer contributes substantially to this buoyancy while the selection of PVC for the outermost layer provides a durable shell for the hose that resists collapse during use. The EVA copolymer is a preferred material for the intermediate layer in view of its ability to adhere the innermost and outermost layers as well as its density, being less than that of water.

In the preferred embodiment of this invention, the hose serves as an element of a pool filtration system or a pool cleaning device. For example the hose can connect a pool “vacuum cleaning” device to a pump that is part of a pool filtration or cleaning system. The hose of the present invention can be connected to and serve as a conduit between the pool vacuum and the filtration pump. The filtration pump would cause a decrease in pressure in the hose that would transfer this pressure differential to the pool vacuum causing the vacuum to suck up water and debris from the pool. The water and debris would then travel through the hose into the filtration pump. The suction provided by the pressure differential could also translate to forward motion for the pool vacuum. The pool vacuum could either be of the floating variety which would clean the surface of the pool's water or of the sinking variety which would clean the floor of the pool. The nature of the hose, being that it is less dense than water, allows it to float thereby substantially obviating the need for additional flotation elements attached to the hose. The floating nature of the hose allows it to avoid becoming tangled as the cleaning device works.

### EXAMPLE

A representative example of the present invention was manufactured using a tri-layer cross head with 3 extruders providing each material for the product. The cross head was a high volume cross head to achieve the large outer diameter/inner diameter dimensions for the application, while maintaining equivalent line speeds to PVC hose produced using in-line tooling. The largest extruder used was a 2.5 inch extruder with a barrier mixing screw for the inner layer, which is the thickest layer of the product, made of the thermoplastic polyolefin elastomer Engage 8556. Process temperatures on this extruder ranged from 330° F to 370° F and the extruder speed ranged from 25 rpm to 35 rpm. The intermediate layer was comprised of the EVA Evax 265 and was formed using a 1.25 inch extruder with a barrier mixing screw. The temperature range was 310° F to 350° F, with an extruder speed of 3 rpm to 8 rpm. The outer layer was comprised of the PVC PTN-775-02 with a durometer of 60 Shore A to 90 Shore A and was formed using a 1.25 inch extruder with a barrier mixing screw. The process temperatures ranged from 330° F to 360° F. The extruder speed was 5 rpm to 15 rpm. The product was run with non-contact vacuum sizing with about 15 inches to about 25 inches of water. After the vacuum tank, the product was cooled in about a 35 foot water trough with the water having a temperature ranging from 45° F to 55° F. A logo was printed on the outer layer of the product using a print wheel. The line speed was 35 feet per minute (fpm) to 50 fpm using a caterpillar style puller. Color was added to the PVC layer as a concentrate with a let down ratio of 2%. The product was cut to length using a flywheel cutter.

For small sizes, it is contemplated that free extrusion could be used to get the size using low pressure air on the inner diameter. The process uses a large volume cross head, with die temperatures ranging from 320° F to 350° F.

The principles, preferred embodiments, and modes of operation of the present invention have been described in the foregoing specification. The invention which is intended to be protected herein, however, is not to be construed as limited to the particular forms disclosed, since these are to be regarded as illustrative rather than restrictive. Variations and changes may be made by those skilled in the art, without departing from the spirit of the invention.

Any range of numbers recited in the specification or paragraphs hereinafter describing various aspects of the invention, such as that representing a particular set of properties, units of measure, conditions, physical states or percentages, is intended to literally incorporate expressly herein by reference or otherwise, any number falling within such range, including any subset of numbers or ranges subsumed within any range so recited.

The term “about” when used as a modifier for, or in conjunction with, a variable, is intended to convey that the numbers and ranges disclosed herein are flexible and that practice of the present invention by those skilled in the art using concentrations, amounts, contents, properties such density, etc., that are outside of the range or different from a single value, will achieve the desired result, namely, providing a multi-layered hose that has a density less than that of water at the same temperature.

Throughout the entire specification, including the claims, the word “comprise” and variations of the word, such as “comprising” and “comprises,” as well as “have,” “having,” “includes,” “include” and “including,” and variations thereof, means that the named steps, elements or materials to which it refers are essential, but other steps, elements or materials may be added and still form a construct with the scope of the claim or disclosure. When recited in describing the invention and in a claim, it means that the invention and what is claimed is considered to what follows and potentially more. These terms, particularly when applied to claims, are inclusive or open ended and do not exclude additional, unrecited elements or methods steps.

For purposes of the present invention, unless otherwise defined with respect to a specific property, characteristic or variable, the term “substantially” as applied to any criteria, such as a property, characteristic or variable, means to meet the stated criteria in such measure such that one skilled in the art would understand that the benefit to be achieved, or the condition or property value desired is met.

1. A multi-layered hose comprising in cross-section, a plurality of layers defining a channel, said hose having a density less than that of water at the same temperature.

2. The multi-layered hose of claim 1, wherein said plurality of layers comprise materials selected from the group consisting of polyolefin thermoplastic elastomers, ethylene vinyl acetate, polyvinyl chloride compositions, copolyester ethers, thermoplastic vulcanizates, saturated styrene block copolymer rubbers and thermoplastic olefin resins, ethylene methyl acrylate, polyolefin elastomer blends, and styrenic block copolymers based on styrene, butadiene and isoprene monomers in all grades.

3. The multi-layered hose of claim 1, wherein said plurality of layers comprises an innermost layer, at least one intermediate layer, and an outermost layer.

4. The multi-layered hose of claim 3, wherein said at least one intermediate layer binds said innermost layer to said outermost layer.

5. The multi-layered hose of claim 1, wherein at least one of said plurality of layers further comprises at least one reinforcing element.

6. The multi-layered hose of claim 5, wherein said at least one reinforcing element is selected from the group consisting of threads, fibers, or woven or nonwoven substrates comprising such threads or fibers and mixtures thereof.

7. The multi-layered hose of claim 6, wherein said reinforcing element is selected from the group consisting of at least one natural or synthetic fibrous material and combinations thereof.

8. The multi-layered hose of claim 3, wherein said innermost layer comprises at least one polyolefin thermoplastic elastomer.

9. The multi-layered hose of claim 8, wherein said at least one polyolefin thermoplastic elastomer is selected from the group consisting of ethylene octene thermoplastic elastomers and ethylene butene thermoplastic elastomers.

10. The multi-layered hose of claim 3, wherein said at least one intermediate layer comprises ethylene vinyl acetate.

11. The multi-layered hose of claim 10, wherein said ethylene vinyl acetate has a vinyl acetate content of about 10% to about 28% by weight.

12. The multi-layered hose of claim 3, wherein said outermost layer comprises a polyvinyl chloride composition.

13. The multi-layered hose of claim 3, wherein said innermost layer is thicker than said at least one intermediate layer and said outermost layer.

14. The multi-layered hose of claim 3, wherein said innermost layer has a thickness of about 0.005 inches to about 1.0 inches.

15. The multi-layered hose of claim 3, wherein said at least one intermediate layer has a thickness of about 0.001 inches to about 1.0 inches.

16. The multi-layered hose of claim 3, wherein said outermost layer has a thickness of about 0.001 inches to about 1.0 inches.

17. The multi-layered hose of claim 1, wherein said multi-layered hose has an overall outer dimension of about 0.01 inches to about 10.0 inches.

18. The multi-layered hose of claim 1, wherein said channel has an inner dimension of about 0.002 inches to about 5.0 inches.

19. The multi-layered hose of claim 1, wherein said multi-layered hose has an overall outer dimension of about 0.76 inches and said channel has an inner dimension of about 0.516 inches.

20. The multi-layered hose of claim 1, wherein said innermost layer and said at least one intermediate layer have a combined total thickness of about 85% to about 95% of the total thickness of said plurality of layers.

21. The multi-layered hose of claim 1, wherein at least one of said plurality of layers is corrugated.

22. The multi-layered hose of claim 1, wherein wherein said plurality of layers comprises an innermost layer, an intermediate layer and an outermost layer, wherein said innermost layer comprises polyolefin thermoplastic elastomer, said at least one intermediate layer comprises ethylene vinyl acetate with a vinyl acetate content of about twenty eight percent, and said outermost layer comprises polyvinyl chloride composition and wherein said innermost layer has a thickness of about 0.109 inches, said intermediate layer has a thickness of about 0.003 inches, and said outermost layer has a thickness of about 0.01 inches, and wherein said hose has a density less than that of water at the same temperature.

23. A floating hose that is less dense than water wherein said densities are measured at the same temperature; said floating hose having a hollow channel defined by a plurality of layers comprising an innermost layer, at least one intermediate layer, and an outermost layer wherein said innermost layer comprises polyolefin thermoplastic elastomer, said at least one intermediate layer comprises ethylene vinyl acetate, and said outermost layer comprises a polyvinyl chloride composition.

24. The floating hose of claim 23, wherein said at least one intermediate layer binds said innermost layer to said outermost layer.

25. The floating hose of claim 23, wherein at least one of said plurality of layers further comprises at least one reinforcing element.

26. The floating hose of claim 25, wherein said at least one reinforcing element is selected from the group consisting of threads, fibers, or woven or nonwoven substrates comprising such threads or fibers and mixtures thereof.

27. The floating hose of claim 26, wherein said reinforcing element is selected from the group consisting of at least one natural or synthetic fibrous material and combinations thereof.

28. The floating hose of claim 23, wherein said ethylene vinyl acetate has a vinyl acetate content of about 10% to about 28% by weight.

29. The floating hose of claim 23, wherein said innermost layer is thicker than said at least one intermediate layer and said outermost layer.

30. The floating hose of claim 23, wherein said innermost layer has a thickness of about 0.005 inches to about 1.0 inches.

31. The floating hose of claim 23, wherein said at least one intermediate layer has a thickness of about 0.001 inches to about 1.0 inches.

32. The floating hose of claim 23, wherein said outermost layer has a thickness of about 0.001 inches to about 1.0 inches.

33. The floating hose of claim 23, wherein said floating hose has an overall outer dimension of about 0.01 inches to about 10.0 inches.

34. The floating hose of claim 23, wherein said hollow channel has an inner dimension of about 0.002 inches to about 5.0 inches.

35. The floating hose of claim 23, wherein said floating hose has an overall outer dimension of about 0.76 inches and said hollow channel has an inner dimension of about 0.516 inches.

36. The floating hose of claim 23, wherein said innermost and said at least one intermediate layer have a total combined thickness of about 85% to about 95% of the total thickness of the plurality of layers.

37. The floating hose of claim 23 wherein at least one of said plurality of layers is corrugated.

38. The floating hose of claim 23, wherein said innermost layer comprises a polyolefin thermoplastic elastomer, said at least one intermediate layer comprises ethylene vinyl acetate, and said outermost layer comprises polyvinyl chloride composition and wherein said innermost layer has a thickness of about 0.109 inches, said intermediate layer has a thickness of about 0.003 inches, and said outermost layer has a thickness of about 0.01 inches.

39. A pool cleaning device comprising the multi-layered hose of claim 1.

40. A pool cleaning device comprising the floating hose of claim 23.

41. The multi-layered hose of claim 1, wherein said multi-layered hose has a burst strength of between about 90 psi to about 180 psi.

42. The floating hose of claim 23 wherein said floating hose has a burst strength of between about 90 psi to about 180 psi.
